(19) United States
(12) Patent Application Publication
(10) Pub. No.: US 2025/0116258 A1
(43) Pub. Date: Apr. 10, 2025

(54) ACTUATOR ASSEMBLY

(71) Applicant: Goodrich Actuation Systems SAS, Vernon (FR)

(72) Inventors: Hippolyte MARRANT, Paris (FR); Dominique POULET, Épiais-lès-Louvres (FR)

(21) Appl. No.: 18/906,731

(22) Filed: Oct. 4, 2024

(30) Foreign Application Priority Data
Oct. 10, 2023 (EP) 23306751.1

(51) Int. Cl. F03G 7/00; F15B 15/14

(52) U.S. Cl. CPC F03G 7/008; F15B 15/1423

(57) ABSTRACT

An electro-hydrostatic actuator (EHA) assembly includes: a power line, and a one-piece, integral housing a hydraulic control block, a power control module, PCM, and a motor-pump assembly, the integral housing comprising a passage through which the power line passes.

### CROSS-REFERENCE TO RELATED APPLICATIONS

This application claims the benefit of European Patent Application No. 23306751.1 filed Oct. 10, 2023, the disclosure of which is incorporated herein by reference in its entirety.

### TECHNICAL FIELD

The present disclosure is concerned with electro-hydrostatic actuators (EHAs) made up of the following sub-assembly: motor-pump, control hydraulic block with integrated hydraulic functions, accumulator, power line, power control module (PCM) and remote electronic unit (REU).

### BACKGROUND

Actuators are used in a wide variety of fields and applications for moving parts or surfaces from one position to another. Actuators are commonly used, for example, in aircraft, for moving flight control surfaces or aircraft parts, doors etc. Many types of actuator are known, including mechanical, hydraulic and electrical actuators and combinations thereof e.g. electro-hydrostatic actuators, EHAs. An actuator typically has an actuator housing, or cylinder, within which an actuator ram or rod is located for axial movement relative to the housing. The rod is moved by application of power to one end of the rod. The other end of the rod is connected to a surface or part to be moved. Power is applied to the rod according to the type of actuator. In some actuators (hydraulic, EHA, etc) the rod is moved by the application of hydraulic fluid provided from a hydraulic assembly in a hydraulic block. The hydraulic block is assembled to the actuator housing. In addition, the EHA assembly includes a motor and pump sub-assembly and is also provided with a power control module (PCM) and a remote electronics unit (REU).

Because the actuator power line is typically subjected to high levels of mechanical stress, it typically needs to be made of a strong material capable of withstanding such stresses, such as steel. On the other hand, such materials are relatively expensive and heavy and it is usually desirable to reduce the overall weight and cost of an actuator assembly. In aircraft, in particular, the weight of aircraft parts should be minimised where possible, for reasons of efficiency. The reduce the overall weight and cost of the actuator assembly, therefore, whilst maintaining the strength of the rod, it is common to fabricate the control block e.g. the hydraulic block, of a lighter material such as aluminium or, for higher pressure applications, titanium. These lighter materials, however, are not suitable for withstanding the high stresses applied to the rod, and so cannot be used for that part.

The other main parts of the actuator assembly e.g. the motor-pump sub-assembly, the PCM and the REU are all conventionally manufactured and supplied as separate parts which are then assembled together. The actuator assembly, especially the housing parts, therefore, typically are formed as a number of separate main structural parts, that are individually forged, machined or cast, that are then assembled together. The requirement for multiple parts to be available to assemble into an actuator assembly increases the number of suppliers and the costs as well as assembly cost, complexity and time. The assembly is also relatively heavy. It would be desirable to have a lighter, simpler, less expensive and less time-intensive actuator assembly.

### SUMMARY

According to the disclosure, there is provided an electro-hydrostatic actuator, EHA, assembly comprising: an actuator power line, and a one-piece, integral housing, housing a hydraulic control block, a power control module, PCM, and a motor-pump assembly, the integral housing comprising a passage through which the power line passes.

A method of making an EHA assembly is also provided.

### BRIEF DESCRIPTION

Examples of an actuator assembly according to this disclosure will now be described with reference to the drawings. It should be noted, that variations are possible within the scope of the claims.

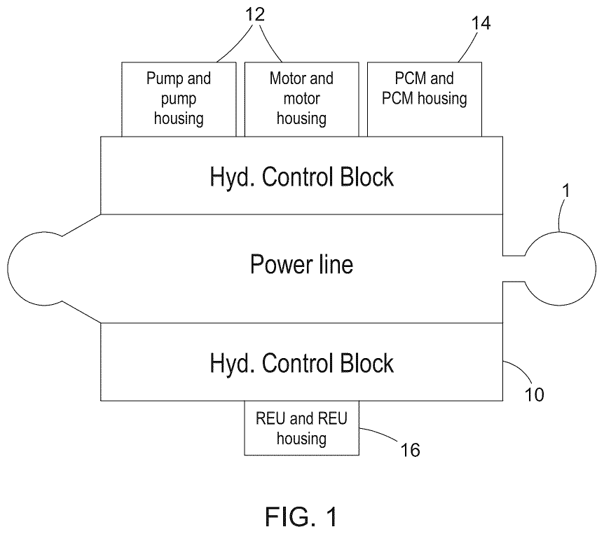

FIG. 1 shows a typical actuator assembly.

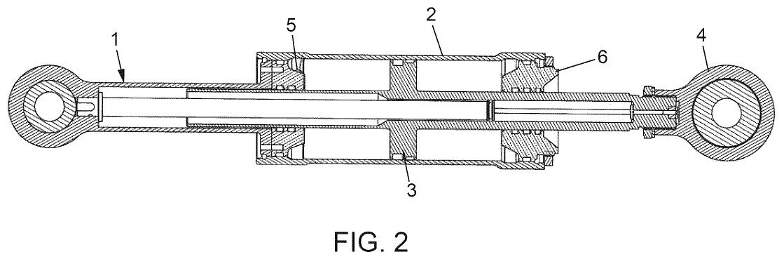

FIG. 2 shows a typical power line assembly

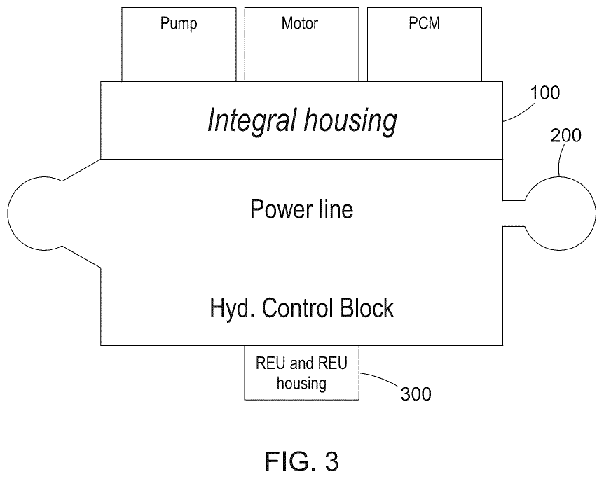

FIG. 3 shows an actuator assembly according to this disclosure.

### DETAILED DESCRIPTION

The EHA shown in FIG. 1 will be briefly described by way of background. The assembly will not be described in detail, since such actuators are well-known.

The power line shown in FIG. 2 will be briefly described by way of background. The assembly will not be described in detail, since such actuators are well-known.

The actuator comprises a power line 1 mounted to a hydraulic block 10. The power line is basically composed of a ram or rod 3 which is slidably located within a cylinder 1 and 2 attached to the structure (This part could either be in one part or in two parts), and moves relative to the cylinder responsive to the application of hydraulic fluid from the block. The rod is guided by two bearings 6 and 5 and links to the movable surface by the rod eye end 4. The actuator is driven by a motor and pump sub-assembly 12 to drive the operation of the hydraulic block to control the rate and direction of hydraulic fluid to move the rod relative to the cylinder. A power control module (here embedded PCM) 14 is mounted to the motor-pump sub-assembly to control the power to the motor-pump sub-assembly 12. Command and monitoring functions are provided by means of an electronics module (here remote electronics unit, REU) 16. The electronics module captures sensor data and sends command data to the actuator and is typically in electrical communication with the actuator via a digital data bus.

As mentioned above, due to the high mechanical stresses to which it is subjected, the power line assembly needs to be made of a strong material that can withstand such stresses, e.g. steel or stainless steel. Conventionally, to minimise overall weight and cost, however, the hydraulic block 10, which is not subjected to such high mechanical stresses, is made of a lighter material such as aluminium or titanium. Each sub-assembly fitted onto the hydraulic block has its own housing. For aircraft applications, these are commonly made of aluminium. These parts are then assembled, e.g. bolted, together to form the actuator assembly. This results in a relatively complex, heavy and expensive multi-part assembly, potentially deriving from multiple, different (and commonly expensive) manufacturing processes.

In the assembly according to the disclosure, examples of which will be described with reference to FIG. 3, a single, integral housing 100 is manufactured to house all of the hydraulic block, the motor-pump sub-assembly and the PCM. In one example, the integral housing is made using additive manufacturing. The integral housing 100 is also formed with a passage to receive the power line 200 therethrough. The actuator cylinder (part of the power line assembly) can be formed as an integral part of the housing or can be a separate cylinder, housing the rod, that fits in the passage of the integral housing. In this way, only a single, integral block need be manufactured, housing all of the hydraulic functions, motor-pump and PCM parts, that can be assembled over the actuator rod (or rod and cylinder). The electronics in the REU 300 will typically need to be separately configured for each actuator assembly and connected by electrical connectors, and, further, will need to be in a non-conductive, water-proof housing. Therefore, the electronics will usually still be formed in a separate REU 300, similar to that of the conventional assembly, and attached to the integral housing, with the appropriate electrical connections made through the integral housing 100.

The integral housing 100 can be moulded, cast, forged or made by additive manufacturing in any size or shape capable of housing the actuator parts mentioned above. The integral housing is shaped to closely contain the relevant parts to keep the housing as compact as possible. Other envelopes are, however, possible.

The parts making up the power line assembly, due to the stress applied to it in use, will typically be made of a stronger material than the integral housing 100, e.g. stainless steel, but it is conceivable that other materials could be used.

By forming a single, integral housing for the major EHA parts, only one part needs to be manufactured and supplied for assembly with the power line 200, rather than several parts that need to be sourced and assembled. The integral housing can be easily and inexpensively formed using additive manufacture and may also be shaped in a topologically optimised form to save on size and weight.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. An electro-hydrostatic actuator (EHA) assembly comprising:
a power line, and
a one-piece, integral housing, the integral housing housing:
a hydraulic control block;
a power control module (PCM); and
a motor-pump assembly;
wherein the integral housing has a passage through which the power line passes.

2. The assembly of claim 1, further comprising an actuator cylinder within which the rod moves axially due to the pressure of hydraulic fluid from the hydraulic block.

3. The assembly of claim 2, wherein the actuator cylinder is also formed in the integral housing.

4. The assembly of claim 1, further comprising:
an electronics unit containing electronic components for performing actuator command and/or monitoring functions, the electronics unit being mounted to the integral housing.

5. The assembly of claim 1, further comprising:
electrical connectors for electrically connecting the electronics unit to sensor or commands lines of the actuator.

6. The assembly of claim 5, wherein the electronics unit sends sensor and/or command signals via a digital data bus.

7. The assembly of claim 1, wherein the integral housing is shaped to define a portion shaped to correspond to the shape of the hydraulic control block, a portion shaped to correspond to the shape of the PCM and a portion shaped to correspond to the shape of the motor-pump sub-assembly.

8. The assembly of claim 1, wherein the integral housing is made of aluminium.

9. The assembly of claim 1, wherein the integral housing is made of titanium.

10. The assembly of claim 1, wherein the rod is made of steel.

11. A method of forming an electro-hydrostatic actuator assembly comprising:
forming a one-piece integral housing housing a hydraulic control block, a power control module and a motor-pump assembly, the integral housing defining a passage therethrough; and
mounting the housing onto an actuator rod, the rod passing through the passage.

12. The method of claim 11, further comprising mounting an electronics unit to the integral housing.
